(19) United States
(12) Patent Application Publication
(10) Pub. No.: US 2019/0108289 A1
(43) Pub. Date: Apr. 11, 2019

(54) SYSTEM FOR EFFICIENTLY CARRYING OUT A DYNAMIC PROGRAM FOR OPTIMIZATION IN A GRAPH

(71) Applicant: BROWN UNIVERSITY, Providence, RI (US)

(72) Inventor: Philip N. Klein, Newton, MA (US)

(21) Appl. No.: 16/012,328

(22) Filed: Jun. 19, 2018

Related U.S. Application Data
(60) Provisional application No. 62/521,816, filed on Jun. 19, 2017.

(51) Int. Cl. G06F 17/30; G06Q 10/04

(52) U.S. Cl. CPC G06F 17/30958; G06F 17/30961; G06Q 10/047

(57) ABSTRACT

System and method for efficiently carrying out a dynamic program for optimization in a graph. A method includes receiving a planar graph equipped with an embedding and edge cost function and a precision parameter, finding an edge subgraph of total cost for some constant, splitting the graph into a collection of subgraphs referred as slabs, for each slab, build a branch decomposition and solve a traveling salesman problem (TSP) exactly on it, returning a union of exact solutions on the slabs, and outputting a total cost.

### CROSS REFERENCE TO RELATED APPLICATIONS

This application claims benefit from U.S. Provisional Patent Application Ser. No. 62/521,816 filed Jun. 19, 2017, which is incorporated by reference in its entirety.

### STATEMENT REGARDING GOVERNMENT INTEREST

This invention was made with government support under grant 1409520 awarded by the National Science Foundation. The government has certain rights in the invention.

### BACKGROUND OF THE INVENTION

The invention generally relates batteries, and more specifically to a system for efficiently carrying out a dynamic program for optimization in a graph.

The traveling salesman problem asks “given a collection of cities connected by highways, what is the shortest route that visits every city and returns to the starting place?” The traveling salesman problem is easy to state, and—in theory at least—it can be easily solved by checking every round-trip route to find the shortest one. The trouble with this brute force approach is that as the number of cities grows, the corresponding number of round-trips to check quickly outstrips the capabilities of the fastest computers. With ten cities, there are more than 300,000 different round-trip. With fifteen cities, the number of possibilities balloons to more than 87 billion.

The answer has practical applications to processes such as drilling holes in circuit boards, scheduling tasks on a computer and ordering features of a genome.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a method including receiving a planar graph equipped with an embedding and edge cost function and a precision parameter, finding an edge subgraph of total cost for some constant, splitting the graph into a collection of subgraphs referred as slabs, for each slab, build a branch decomposition and solve a traveling salesman problem (TSP) exactly on it, returning a union of exact solutions on the slabs, and outputting a total cost.

In another aspect, the invention features a system including a processor and a memory, the memory including at least an operating system and a process, the process including receiving a planar graph equipped with an embedding and edge cost function and a precision parameter, finding an edge subgraph of total cost for some constant, splitting the graph into a collection of subgraphs referred as slabs, for each slab, build a branch decomposition and solve a traveling salesman problem (TSP) exactly on it, returning a union of exact solutions on the slabs, and outputting a total cost.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. So that those having ordinary skill in the art to which the disclosed system appertains will more readily understand how to make and use the same, reference may be had to the following drawings.

These and other features, aspects, and advantages of the present invention will become better understood with reference to the following description, appended claims, and accompanying drawings where:

FIG. 1 illustrates an exemplary graph.

FIG. 2 illustrates an exemplary graph.

FIG. 3 illustrates an exemplary graph.

FIG. 4 illustrates an exemplary graph.

FIG. 5 illustrates an exemplary graph.

FIG. 6 illustrates an exemplary graph.

FIG. 7 illustrates an exemplary graph.

FIG. 8 is a block diagram of an exemplary computer system.

FIG. 9 is a flow diagram.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

One goal of the present invention is to quickly and efficiently carry out a branch-decomposition dynamic program solving an optimization. A branch decomposition of a graph is a binary recursive decomposition of a graph into clusters of edges. For each cluster, there is a small number of vertices incident both to edges in the cluster and edges outside the cluster—these are called boundary vertices. The same idea can be applied to similar recursive decompositions, such as tree decompositions or carving decompositions. For any cluster C (except the one consisting of all edges of the graph), there is a smallest cluster that properly contains C, called the parent of C. Each cluster is the parent of either zero or two children clusters.

Our dynamic process processes the clusters from smallest to largest. For each cluster, the dynamic program builds a table indexed by configurations. The configurations of a cluster describe how the solution to an optimization problem might interact with the boundary vertices. For each configuration of a cluster, the table for the cluster maps that configuration to the minimum cost of a solution consistent with that configuration. The dynamic program builds the table for the parent cluster from the tables for the two children clusters.

One challenge is (A) just making the process efficient. Another more specific challenge (B) arises from the fact that we cannot afford the time to complete the full table for every cluster because there are just too many configurations; we need a technique to carry out an incomplete dynamic program.

The naive approach to build up the table for the parent cluster is this: enumerate all the configurations X for child cluster 1, enumerate all the configurations Y for child cluster 2, and, for each pair (X,Y), find the corresponding configuration Z for the parent cluster (if such a configuration exists) and update the table entry corresponding to Z.

The naive approach enumerates many more pairs (X,Y) than necessary even for the complete dynamic program because most such pairs do not correspond to a valid configuration of the parent cluster (we say of such pairs that they are not consistent). What determines whether X and Y are consistent is what they specify for those vertices that are boundary vertices of both clusters (the shared boundary vertices). Therefore we use the following approach.

1. Organize the configurations for child cluster 1 into groups so that all the configurations in a group specify the same pattern on the shared boundary vertices.
2. Similarly organize the configurations for child cluster 2.
3. Note that, for each group G₁ from Step 1 and each group G₂ from Step 2, either every configuration in Gᵢ is consistent with every configuration in G₂, or none is. We can therefore say of a pair G₁, G₂ of groups that the two groups are consistent or not.
4. Form a mapping that, for each group G₁ from Step 1, map it to the set of groups from Step 2 that are consistent with G₁.

The above data structures enable the algorithm to enumerate pairs of configurations that are consistent (without considering inconsistent pairs). There are many ways to enumerate such pairs. For example, one can use the following approach:

for each group G₁, from Step 1,

for each group G₂ in the set G₁, maps to,
for each configuration X in G₁,
   for each configuration Y in G₂,
      construct the parent cluster configuration corresponding to
         the pair (X, Y) of consistent configurations of child clusters

Because there are just too many configurations, we need a technique to carry out an incomplete dynamic program. A key is generating configurations of the parent cluster in nondecreasing order of cost (or, equivalently, nonincreasing order of profit). That way, if the process of generating configurations stops before completion, the configurations that have been generated so far are no more costly than those that have not yet been generated. This in turn makes it more likely that the configurations that have been generated will be useful in constructing good configurations in subsequent parents and ultimately in forming a good solution.

At what point does the generation process stop? Examples of reasonable termination conditions are: the number of parent cluster configurations generated reaches some specified threshold, the number of child cluster configuration reaches some threshold, or all remaining unenumerated parent cluster configurations are more costly than some specified threshold. The threshold can depend on the cluster itself.

A key observation is that there is an efficient method for generating parent cluster configurations in order of cost efficient in that the computational time increases almost linearly with the number of child cluster configuration pairs enumerated.

One method for generating parent cluster configurations in order is this:

1. Ensure that each group Gᵢ of configurations of child cluster i is in sorted order with respect to cost.
2. Use a priority queue. Initially there is one entry for each consistent pair (G₁,G₂) of groups of child cluster configurations. The entry consists of a pair (p₁, p₂) where pᵢ is the pointer to the beginning of the sequence of configurations in group Gᵢ. In general, entries are pairs (p₁, p₂) where p₁ and p₂ are pointers into such sequences. The key of the entry is the cost of the pair of child-cluster configurations pointed to by p₁ and p₂, i.e., the sum of costs of the two configurations as given by the tables previously computed for the child clusters.
3. The process of generating parent configurations in order is as follows. At any moment in the process, the first element in the priority queue is a pair of pointers (p₁, p₂) such that the pair of configurations pointed to by p₁ and p₂ is the least cost pair of consistent child-cluster configurations that has not yet been enumerated.

Process this pair of configurations, generating the parent configurations.

Remove the pair (p₁, p₂) from the priority queue.

Insert the pair (p₁, p₂+1) into the priority queue, using as the key the cost of the corresponding pair of configurations.

If p₂ is pointing to the beginning of its sequence then also insert the pair (p₁+1, p₂) into the priority queue.

In embodiments, the present invention is a linear-time approximation scheme for the traveling salesman problem on planar graphs with edge weights. Recognizing that the theoretical algorithm involves constants that are too large for practical use, the present invention, which is not subject to the theoretical algorithm's guarantee, can quickly find good tours in very large planar graphs.

Many, if not most, polynomial-time approximation schemes (PTASs) for the traveling salesman problem (TSP) and related problems suffer from gigantic constant Factors. Fully described herein in a system that implements a TSP approximation scheme, adapted and engineered so that it is no longer guaranteed to find near-optimal tours but it runs quickly. Our system typically runs in less than a millisecond per vertex and provides significantly better tours than similarly fast heuristics on very large graphs. This implementation is a step toward implementing more complicated, related approximation schemes for other problems, including Subset TSP, in which the tour need only visit a given subset of the vertices. It is also a step towards implementing a method that can cope with the non-planarities and asymmetry of real road networks. This is valuable because there is potential to address other problems arising in road networks, such as ride-sharing, package-delivery routing, and public transportation layout.

Throughout this detailed description, all graphs are considered are planar and embedded. The dual of a planar graph G is the graph whose vertices are the faces of G, with edges between faces which share a boundary edge. The radial of a planar graph G is the bipartite graph whose vertices are the union of the vertices of G and the faces of G, with edges between each incident vertex-face pair.

A branch decomposition of a graph is a rooted binary tree and a bijection between leaves of the tree and edges of the graph. Each edge e of the tree defines a cluster of graph edges, namely those edges corresponding to the tree leaves whose leaf-to-root path contains e. The boundary of a cluster is the set of all vertices with at least one incident edge within the cluster and one not within the cluster. The width of a branch decomposition is the maximum cardinality of any cluster's boundary. The branchwidth of a graph is the minimum width of any branch decomposition of the graph. By considering only interactions on the boundary, branch decompositions are amenable to dynamic programming.

A sphere cut decomposition is a branch decomposition where, for each cluster, a Jordan curve intersects no edges and exactly the boundary vertices. This induces a cyclic order to the boundary. In a planar graph whose radial graph has radius k, a sphere cut decomposition of width at most k+1 can be found in linear time using Tamaki's heuristic (M. Müller-Hannemann and S. Schirra, editors. Algorithm engineering: bridging the gap between algorithm theory and practice, volume LNCS 5971. Springer, 2010).

Let OPT(G) be the minimum cost of a TSP tour of graph G and MST(G) be the cost of a minimum spanning tree of G. Given that MST(G)<OPT(G)2MST(G), giving a trivial 2-approximation algorithm. Christofides' algorithm gives a 1.5-approximation, but requires computing a minimum-weight perfect matching, for which no nearly linear-time algorithm is known on planar graphs.

The method of the present invention broadly includes four steps, described herein without the compromises necessary for fast runtimes:

1. Cost reduction: find an edge subgraph G₁CG₀ of total cost at most c(G₁)=(1+2/ε₁)OPT(G₀), for some ε₁ depending only on ε such that OPT(G₀)≤OPT(G₁)≤(1+ε₁)OPT(G₀). The subroutine SPPANER provided by Klein satisfies these requirements and is practical.
2. Slab decomposition: spilt the graph into a collection of subgraphs called slabs, each of which has branchwidth at most 2/ε₂+3 such that each vertex appears in at least one slab, and the sum of the cost of optimal TSP tours on the slabs is at most OPT(G₁)+2ε₂c(G1), where ε₂ is a constant depending only on ε.
3. Dynamic programming: for each slab, build a branch decomposition and solve TSP exactly on it. For each cluster in the decomposition, we build a table of configurations and their corresponding costs: all relevant interactions between the interior and the exterior of the cluster. A tight upper bound on the number of configurations per cluster of width k is M(k)=going from i=0 to k, the sum of C₂ₖ₋₁(k/i) where Cⱼ is the jth Catalan number.
4. Combining: return the union of the exact solutions on the slabs.
The final output has a total cost at most

OPT(G₁)+2ε₂c(G₁)≤(1+ε₁)OPT(G₀)+2ε₂(1+2/ε₁)MST(G₀)

<(1+ε₁)OPT(G₀)+2ε₂OPT(G₀)+4ε₂/ε₁OPT(G₀)

=(+ε₁+2ε₂+4ε₂/ε₁)OPT(G₀).

The parameters should be picked so the ε1+2ε2+4ε₂/ε₁=ε, so ε2 ought to be Ω(ε²₁). The cost reduction, slab decomposition, and combining steps each takes linear time independent of parameter ε. The runtime dynamic program is O(M(2/ε₂+3)²|V(G0)|, as nearly all pairs of configurations from the two clusters might need to be considered (up to M(2/ε₂+3)²|2). As an example of the “gigantic constant factors” from the introductory quotation, in order to achieve a 1.1-approximation under this analysis, picking ε₁ about 1/20 (so that ε₂ is about 1/1640) maximizes ε₂; M(2/ε₂+3) exceeds 10⁴²⁶⁵. This analysis is tight up to a small constant factor. We benefit from the pessimism of worst-case analysis in several places. First, MST(G₀) frequently costs significantly less than OPT(G₀). Second, frequently the branchwidth is less than the theoretical upper bound. Third, the total cost of slab boundaries is typically much less than 2ε₂c(G₁). Furthermore, some edges in slab boundaries also belong to optimal solutions. Finally, the structure of the sphere-cut decompositions we use ensures that only rarely are two clusters merged in a way that requires considering a number of configuration pairs that is at all close to the theoretical upper limit.

As part of our input, we take parameters ε₂ and ε₂ separately, as their effects in practice differ from the theoretical guarantees.

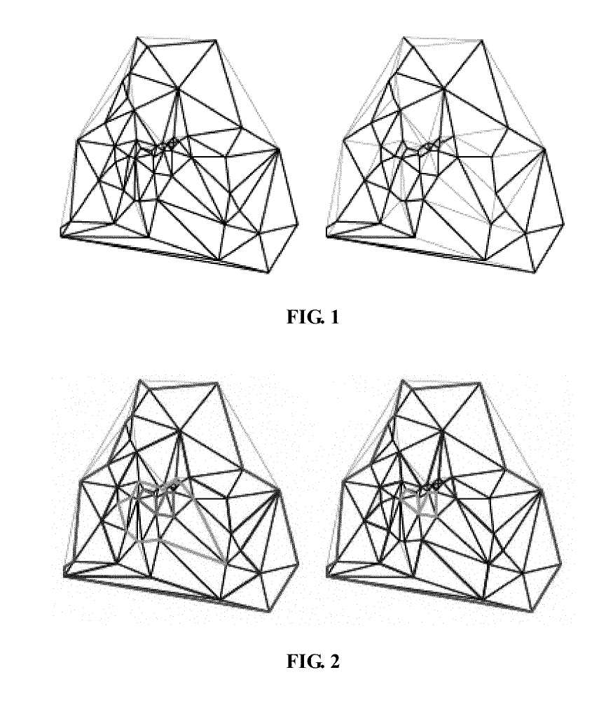

Cost reduction. The implementation finds graph G₁ from G₀. On a planar graph, this can be done in linear time. In practice, though, we use Kruskal's algorithm and observe that the time spent building a minimum spanning tree is usually less than 0.001% of the total runtime under reasonable choices of ε₁. Refer to FIG. 1 for examples of two spanners on a small graph. Slab decomposition. The implementation performs a breadth-first search of the dual graph. This partitions the dual edges into two types: those with endpoints on the same level of the search tree (type A) and those with endpoints on different levels (type B). Each edge is assigned a level by the minimum level of its endpoints. Level interval (i,j) consists of all type A edges with level in [i+1,j] and all type B edges with level in [i,j]. The type B edges of level i form the upper seam and the type B edges of level j form the lower seam. The edges in a level interval can induce a slab. The slabs used will have the property that the only edges shared between slabs are seams and the only vertices shared between slabs are incident to seam edges. Refer to FIG. 2.

Dynamic program. Essentially all of the runtime is spent in the dynamic program. Because of this, most of the complexity in the implementation focuses on efficiently finding pairs of compatible configurations and merging compatible pairs into a parent configuration, and it is here that the choice of engineering techniques have the greatest impact.

Each non-root, non-leaf cluster in a sphere cut decomposition has a sibling and a parent. Furthermore, since each cluster is bounded by a Jordan curve, a natural cyclic order is assigned to the cluster's boundary vertices.

Since a TSP tour can enter or exit a cluster at most twice per vertex (subsequent crossings can be uncrossed), we split each boundary vertex into two portals, representing these potential connections. An involution is stored mapping portals to portals: each portal is associated with another (or to itself, when there is no entrance/exit at the portal). This involution is stored in two different ways, depending on the context: either as small integers representing the portal number or using nested parentheses (really, an array of enum objects) where matching parentheses map to one another (since TSP tours in planar graphs can be uncrossed).

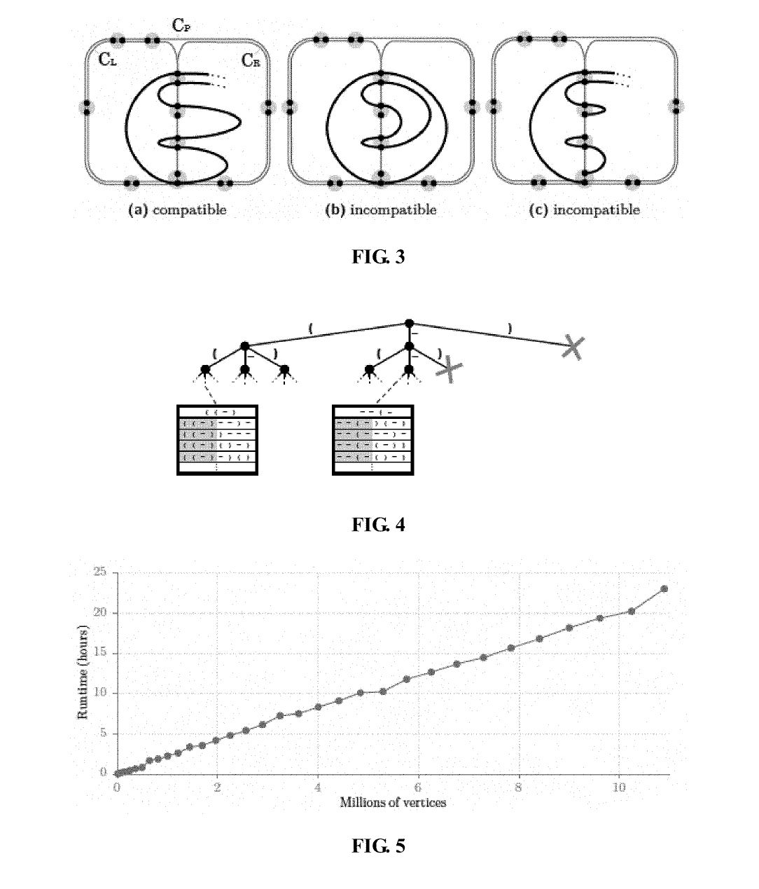

The prefix of a cluster's portals is the interval of portals common to both children in the cyclic order induced by the cluster's bounding Jordan curve. Whether two child-cluster configurations are compatible can be determined mostly by comparing the section of the configurations corresponding to the prefix portals. Cycles formed between prefix portals not shared with the parent cluster indicate incompatible configurations because the final tour must be connected. Additionally, the child-cluster configurations must agree on the presence of a crossing at a prefix portal. That is, if a portal is mapped to itself on one side, it is mapped to itself on the other. FIG. 3 illustrates examples of prefix compatibility.

FIG. 3 illustrates prefix configuration pairs for merging child clusters CL and CR into parent cluster CP: gray circles represent boundary vertices, black circles represent portals, and black lines represent tour segments. Starting with the uppermost shared vertex and going down, the left prefix configuration [(,(,),-,(,),-,)] is (a) compatible with the right prefix configuration [(,(,(,-,),(,-,)], (b) incompatible with the right prefix configuration [(,(,(,-,),),-,)] because the inner prefix cycle indicates a disconnected tour, and (c) incompatible with the right prefix configuration [(,(,(,),-,(,),-] because the crossings do not align.

In practice, computing the entire dynamic programming table is prohibitively expensive: merging two clusters with boundary size just 5 theoretically requires considering over 20 times more pairs of configurations than there are vertices in the largest road network publicly available for testing; in order for the algorithm to “act” like it is linear time, clusters must discard some configurations. We limit each cluster to hold the λ best configurations found, plus one corresponding to the MST-based 2-approximation of the original graph to ensure that there is always a solution.

Rather than generating all pairs of compatible configurations and selecting the best, we generate them in order of increasing cost as follows. The configurations for each cluster are partitioned such that if a configuration is compatible with one configuration in a part, it is compatible with each other configuration in the part. Partitioning by equivalence classes on prefixes suffices. These parts can be efficiently stored as lists sorted by non-decreasing cost at the leaves of a trie. Each root-to-leaf path is the prefix in the nested-parenthesis representation common to all the configs stored at the leaf (see FIG. 4). In FIG. 4, each leaf of the trie corresponds to the prefix configuration generated by the root-to-leaf path. Configurations are grouped by prefix and stored (sorted by cost) at these leaves. Two such leaves are shown. The crossed-off trie branches represent invalid prefix configurations.

Once compatible pairs of leaves are found by traversing the tries for the child configurations in tandem, pairs of pointers to the lists' first elements are inserted into a min-heap keyed by the sum of the costs of the pointed-to elements. To get the next cheapest configuration, one pops the heap. Then, the appropriate pointer is incremented and the pair is re-inserted into the heap. Just popping the heap X times is insufficient, as some of these pairs might yield the same parent configurations. Instead, the heap is popped and parents are formed until have been collected. The actual formation of parent configurations from a compatible pair of child configurations is delayed until necessary, as this transformation turns out to be a bottleneck.

Post processing. As a post-processing heuristic, some number of tours, determined by an input parameter, are produced by running the full algorithm with several different slab decompositions. We then make a new graph from the union of the edges used in these tours and run the PTAS on this.

Tours output by the PTAS typically are very suboptimal around slab boundaries. Recursively re-solving on the graph induced by the set of edges occurring in the tour is effective. The maximum permitted recursion depth is another parameter of the implementation.

Our implementation exhibits linear runtime. FIG. 5 shows the running time of the algorithm, with an arbitrary, realistic choice of parameters, on a series of synthetic square grids as described above. Over 99.99% of the time on large instances is spent in the dynamic program; a plot of the runtime breakdown would be uninteresting.

There are two aspects of evaluating the quality of the tours returned by our process: how close to optimal the tours are and how our solutions compare to other implementations. To address the former, we compute lower bounds on tour lengths, as fully described below. For large graphs however, the latter point poses a problem. Leading TSP implementations require all-pairs distances, which is infeasible for very large non-Euclidean instances. We compare the performance of our process with two different MST-based heuristics:

The 2MST heuristic doubles the edges of the minimum-spanning-tree.

The Shortcut 2MST heuristic follows the tour of the 2MST heuristic but takes shortcuts to avoid unnecessarily re-visiting vertices.

Fast PTAS is our process with a quicker-running set of parameters.

Slow PTAS is our process with a slower-running set of parameters.

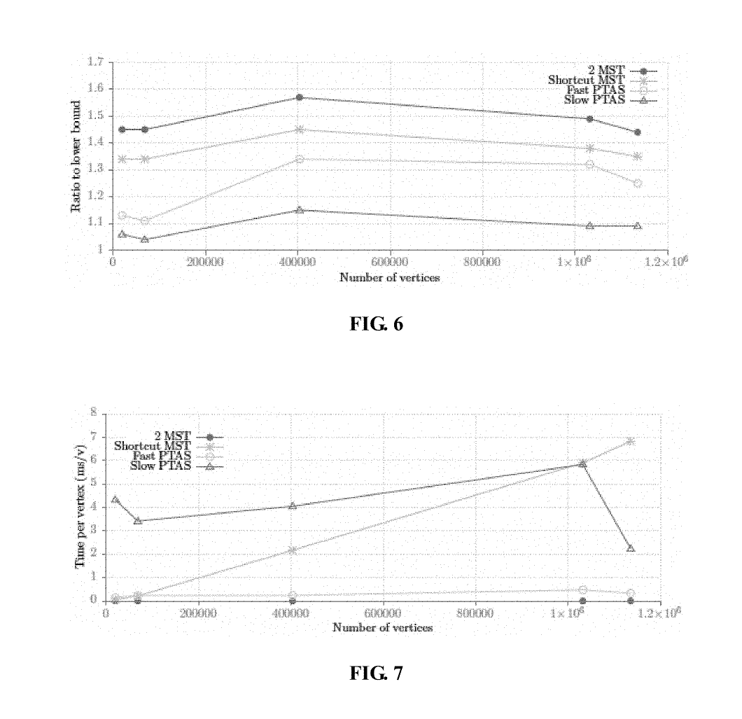

The ratios of tour lengths to lower bounds, given in Table I and depicted in FIG. 6, provide upper bounds for solution error.

TABLE 1

| | | | | Shortcut | | |
|---|---|---|---|---|---|---|
| | | | 2MST | 2MST | Fast PTAS | Slow PTAS |
| Graph | #Vertices | LB | val/LB\|ms/v | val/LB\|ms/v | val/LB\|ms/v | val/LB\|ms/v |
| rochester | 19488 | 98415824 | 1.45 \| <0.01 | 1.34 \| 006 | 1.13 \| 0.15 | 1.06 \| 4.33 |
| tulsa | 68335 | 65840000 | 1.45 \| <0.01 | 1.34 \| 0.22 | 1.11 \| 0.23 | 1.04 \| 3.41 |
| dallas | 403393 | 36332200 | 1.57 \| <0.01 | 1.45 \| 2.17 | 1.34 \| 024 | 1.15 \| 4.05 |
| chicago | 1032016 | 31782700 | 1.49 \| <0.01 | 1.38 \| 5.90 | 1.32 \| 0.48 | 1.09 \| 5.83 |
| losangelos | 1135323 | 53903389 | 1.44 \| <0.01 | 1.35 \| 6.83 | 1.25 \| 0.34 | 1.09 \| 2.24 |

We additionally report the runtime in milliseconds per vertex (see FIG. 7). The 2MST heuristic runs extremely quickly even on very large graphs but provides a poor approximation. The Shortcut 2MST heuristic slightly outperforms the basic 2MST heuristic but takes much longer to find (the running time is superlinear in graph size). Our Fast PTAS tours are found very quickly and show a substantial improvement over 2MST, and our Slow PTAS tours are close to optimal.

To explore the effects of various parameters on runtime and tour cost, we ran a parameter sweep across six graphs and a variety of settings of each of four parameters: slab height (1/ε₂), number of configurations (λ), number of re-solves, and number of tour unions. We examined each parameter separately to identify trends in the effects on runtime and tour cost. In particular we wanted to identify parameter settings that exhibited a promising cost-runtime tradeoff.

The number of retained configurations, λ, appears to have only a weak association to tour quality, but very fast runtimes require small λ values. Recall that the algorithm returns a tour composed of the union of slab tours which is often very suboptimal at the slab seams; re-solving on the graph induced by edges of the initial resulting tour (and iterating several times) can greatly improve tour quality with minimal increase in runtime. Similarly, taking the union of several solutions and re-solving on the resulting graph comprised of the union of the tours also improves tour quality. In both of these post-processing strategies the branchwidth of the graph used to re-solve TSP is typically much smaller than that of the original graph, which both substantially changes the slab decomposition and decreases the runtime.

Interestingly and unexpectedly, larger slab heights (smaller ε₂) produce worse solutions. We attribute this to all values of being too small: the configurations kept in any cluster are only a tiny subset of potential configurations, increasing the odds of missing an important one.

Overall, we see that some parameters (such as number of repeats and unions) have clear benefits to tour quality whereas other parameters have more complicated and intricate effects and potential dependencies.

We needed a way to evaluate the quality of the tours found by our process. Other implementations include subroutines for computing lower bounds but none supported finding a lower bound on a graph with many vertices where distances between vertices take more than a few hundred nanoseconds to compute.

We wrote a procedure to find an approximately optimal solution to the dual of the linear program (LP) that optimizes over the subtour elimination polytope. This LP is:

min c·x:x≥0,Σ{xₑ:e∈(S)}≥2 for every nontrivial subset S⊆V

where there is a variable xₑ for each edge and a constraint for each nontrivial cut in the graph. A nontrivial cut is the set of edges between the two parts of a bipartition of the vertices. For a subset S of vertices, δ(S) is the set of edges between S and V−S.

The above LP is a relaxation of TSP: any tour induces an LP solution of the same value. Therefore, the value of the LP is at most the value of the best tour.

Our procedure computes a solution to the dual of the above LP, namely

max 2̅·y:y≥0,Σ{ys:e∈δ(S)}≤cₑ for every edge e.

This LP ham a variable y_{S} assigning a weight to every cut δ(S). For each edge e, the total weight of cuts containing e is required to be at most the cost of e. The goal is to maximize twice the sum of the cut edges. This is called a packing of cuts. By LP duality, the value of this LP equals the value of the LP with the subtour elimination constraints.
Our procedure approximates the value of the packing LP using an approximation scheme for solving fairly general mathematical programs (packing/covering) via solving a sequence of simpler mathematical programs. In this application of the method, in each iteration the procedure must find a cut whose weight is less than a threshold. The weights are adjusted in each iteration. In particular, in each iteration the procedure increases the weights of edges in the cut just selected, and adjusts the threshold. The number of iterations grows as O(ε⁻²m log m) where m is the number of edges. Each iteration of the implementation takes a step that is larger than that prescribed by theory; the implementation uses binary search to find the largest step size that preserves the algorithm's invariant.

The main work in each iteration is to find a cut of weight less than the threshold. There is a near-linear-time algorithm for min-weight cut in planar graphs. The algorithm uses shortest-path separators, divide-and-conquer, and an O(n log n) algorithm for minimum st-cut in a planar graph. We implemented this algorithm but using it to implement an iteration is far too slow for our purposes. We therefore used it as the basis for a dynamic min-cut algorithm.

The divide-and-conquer algorithm forms a balanced binary tree, a recursive-decomposition tree: each internal node has an associated min st-cut instance on a subgraph, and each leaf has an associated global min-cut instance. The dynamic algorithm maintains a priority queue of solutions to these instances, ordered according to the weights of the solutions. However, the algorithm does not automatically update the solutions or the priority queue when edge-weights increase.

When the LP algorithm requests a cut of weight less than a threshold, the dynamic algorithm examines the cut in the priority queue whose key is smallest, and computes the true weight of the cut (i.e., with respect to current edge-weights). If the true weight is less than the threshold, the dynamic algorithm returns it; if not, the algorithm puts the corresponding instance in a queue of instances to reprocess, and moves on to the next cut in the priority queue. Once the cuts in the priority queue are exhausted and no cut of weight less than the threshold has been found, the algorithm turns to the queue of instances to reprocess; it selects the smallest of these instances and recomputes the corresponding cut. If that cut's weight is still not less than the threshold, the algorithm goes to the next larger instance, and so on. If this queue is exhausted, the algorithm starts from scratch, recomputing shortest-path separators and the recursive-decomposition tree.

As predicted by theory, the runtime of the lower bound procedure depends quadratically on the inverse of the precision parameter ε. Also as predicted by theory, the number of iterations grows as O(n log n). The runtime appears to scale slightly superlinearly with the size of the graph, illustrating the empirical effectiveness of our dynamic min-cut algorithm.

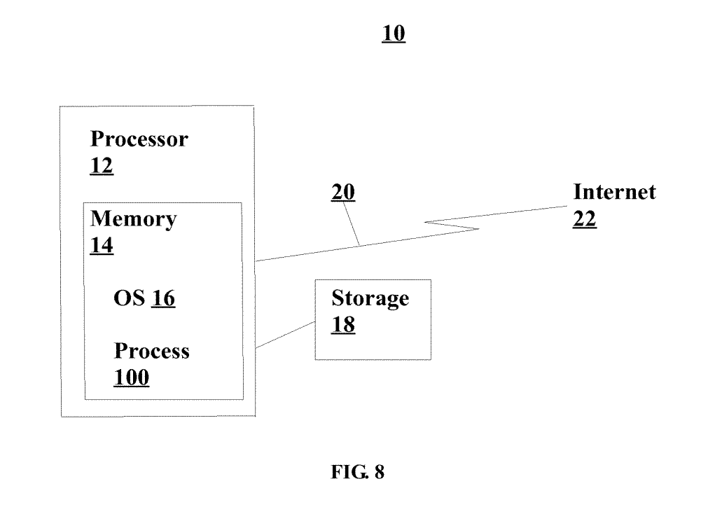

The processes fully described above are carried out on a computer system. As shown in FIG. 8, one such exemplary computer system 10 includes a processor 12 and memory 14. Memory 14 includes an operating system (OS) 16, such as Linux®, Snow Leopard® or Windows®, and a process 100 for efficiently carrying out a dynamic program for optimization in a graph. The system 10 may include a storage device 18 and a communications link 20 to a network of interconnected computers 22 (e.g., the Internet).

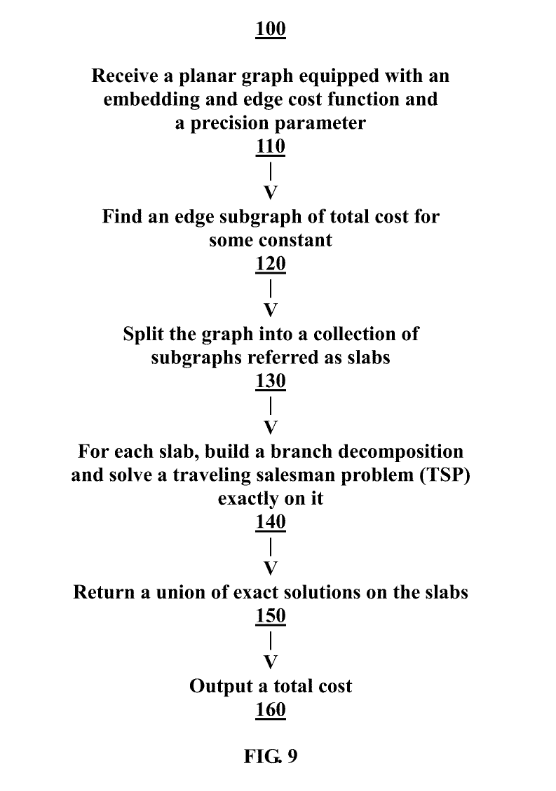

As shown in FIG. 9, a process 100 for efficiently carrying out a dynamic program for optimization in a graph includes receiving (110) a planar graph equipped with an embedding and edge cost function and a precision parameter.

Process 100 finds (120) an edge subgraph of total cost for some constant and splits (130) the graph into a collection of subgraphs referred as slabs.

For each slab, process 100 builds (140) a branch decomposition and solves a traveling salesman problem (TSP) exactly on it, returns (150) a union of exact solutions on the slabs, and outputs (160) a total cost.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method comprising:
in a computer system including at least a memory and processor, receiving a planar graph equipped with an embedding and edge cost function and a precision parameter;
finding an edge subgraph of total cost for some constant;
splitting the graph into a collection of subgraphs referred as slabs;
for each slab, build a branch decomposition and solve a traveling salesman problem (TSP) exactly on it;
returning a union of exact solutions on the slabs; and
outputting a total cost.

2. The method of claim 1 wherein the edge subgraph is G₁CG₀ of total cost at most c(G₁=(2/ε₁)MST(G₀) for constant ε₁ depending only on e such that OPT(G₀)≤OPT(G₁)≤(1+ε₁)OPT(G₀).

3. The method of claim 1 wherein the collection comprises:
a bandwidth at most 2/ε₂+3 such that each vertex appears in at least one slab and a sum of costs of optimal TSP tours on the slabs is at most OPT(G₁)+2ε₂c(G1), where ε₂ is a constant depending only on ε.

4. The method of claim 1 wherein building the branch decomposition and solving the TSP comprises, for each cluster, building a table of configurations and their corresponding cost.

5. The method of claim 4 where a tight upper bound on the number of configurations per cluster of width k is
$$M ( k ) = {\sum }_{i = 0}^{k} {C}_{2 k - i} ( \begin{matrix}k \\ i\end{matrix} )$$
where Cⱼ is the jth Catalan number.

6. The method of claim 1 wherein the total cost is OPT(G₁)+2ε₂c(G₁)≤(1+ε)OPT(G₀)+2ε₂(1+2/ε₁)MST(G₀)<(1+ε₁)OPT(G₀)+2ε₂OPT(G₀)+4ε₂/ε₁OPT(G₀)=(1+ε₁+2ε₂+4ε₂/ε₁)OPT(G₀).

7. A system comprising:
a processor; and
a memory, the memory comprising at least an operating system and a process, the process comprising:
receiving a planar graph equipped with an embedding and edge cost function and a precision parameter;
finding an edge subgraph of total cost for some constant;
splitting the graph into a collection of subgraphs referred as slabs;
for each slab, build a branch decomposition and solve a traveling salesman problem (TSP) exactly on it;
returning a union of exact solutions on the slabs; and
outputting a total cost.

8. The system of claim 7 wherein the edge subgraph is G₁CG₀ of total cost at most c(G₁=(2/ε₁)MST(G₀) for constant ε₁ depending only on ε such that OPT(G₀)≤OPT(G₁)≤(1+ε₁)OPT(G₀).

9. The system of claim 7 wherein the collection comprises:
a bandwidth at most 2/ε₂+3 such that each vertex appears in at least one slab and a sum of costs of optimal TSP tours on the slabs is at most OPT(G₁)+2ε₂c(G1), where ε₂ is a constant depending only on ε.

10. The system of claim 7 wherein building the branch decomposition and solving the TSP comprises, for each cluster, building a table of configurations and their corresponding cost.

11. The system of claim 10 where a tight upper bound on the number of configurations per cluster of width k is
$$M ( k ) = {\sum }_{i = 0}^{k} {C}_{2 k - i} ( \begin{matrix}k \\ i\end{matrix} )$$
where Cⱼ is the jth Catalan number.

12. The system of claim 7 wherein the total cost is OPT(G₁)+2ε₂c(G₁)≤(1+ε)OPT(G₀)+2ε₂(1+2/ε₁)MST(G₀)<(1+ε₁)OPT(G₀)+2ε₂OPT(G₀)+4ε₂/ε₁OPT(G₀)=(1+ε₁+2ε₂+4ε₂/ε₁)OPT(G₀).
